(19) United States
(12) Patent Application Publication
(10) Pub. No.: US 2006/0093885 A1
(43) Pub. Date: May 4, 2006

(54) Compositions containing functionalized carbon materials

(76) Inventors: Paul J. Krusic, Wilmington, DE (US); Helen S. M. Lu, Wallingford, PA (US); Zhen-Yu Yang, Hockessin, DE (US); Clarence G. Law, Newark, DE (US); Joselyn Hicks Garner, Venice, CA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/205,422

(22) Filed: Aug. 17, 2005

Related U.S. Application Data
(60) Provisional application No. 60/603,090, filed on Aug. 20, 2004.

(51) Int. Cl. C08J 5/22; H01M 4/96; H01M 4/90; H01M 4/86

(52) U.S. Cl. 429/33; 521/27; 429/44; 429/41; 429/42

(57) ABSTRACT

Compositions containing functionalized carbon materials and their use, for example, as films for membranes or in other fabricated forms in electrode assemblies for electrochemical cells and fuel cells such as fuel cells are described.

This application claims the benefit of U.S. Provisional Application No. 60/603,090, filed Aug. 20, 2004, which is incorporated in its entirety as a part hereof for all purposes.

### FIELD OF THE INVENTION

This invention relates to compositions containing functionalized carbon materials and their use as films or in other fabricated forms in the field of electronics in devices such as membranes, electrode assemblies and electrocatalysts as found in electrochemical cells and fuel cells.

### BACKGROUND OF THE INVENTION

Electrochemical cells are devices that convert fuel and oxidant to electrical energy. Electrochemical cells generally include an anode electrode and a cathode electrode separated by an electrolyte. A variety of known electrochemical cells fall within a category of cells often referred to as solid polymer electrolyte (SPE) cells. An SPE cell typically employs a membrane of an ion exchange polymer that serves as a physical separator between the anode and cathode while also serving as an electrolyte. SPE cells can be operated as electrolytic cells for the production of electrochemical products or they may be operated as fuel cells for the production of electrical energy. The most well known fuel cells are those which operate with gaseous fuels such as hydrogen and with a gaseous oxidant, usually pure oxygen or oxygen from air, and those fuel cells using direct feed organic fuels such as methanol.

In some SPE cells including many fuel cells, a cation exchange membrane is employed, and protons are transported across the membrane as the cell is operated. Such cells are often referred to as proton exchange membrane (PEM) cells. For example, in a cell employing the hydrogen/oxygen couple, hydrogen molecules (fuel) at the anode are oxidized donating electrons to the anode, while at the cathode the oxygen (oxidant) is reduced accepting electrons from the cathode. The H+ ions (protons) formed at the anode migrate through the membrane to the cathode and combine with oxygen to form water. In many fuel cells, the anode and/or cathode are provided by forming a layer of electrically conductive, catalytically active particles, usually also including a polymeric binder, on the proton exchange membrane, and the resulting structure (sometimes also including current collectors) is referred to as a membrane electrode assembly or MEA.

Membranes made from a cation exchange polymer such as perfluorinated sulfonic acid polymer have been found to be particularly useful for MEAs and electrochemical cells due to good conductivity and good chemical and thermal resistance which provide long service life before replacement. However, increased proton conductivity is desired for some applications, particularly for fuel cells that operate at high current densities.

A need thus remains in the art for compositions having properties that make them desirable for use as films from which membranes may be fabricated, which compositions also have desirable properties in other applications in the field of electronics.

### SUMMARY OF THE INVENTION

One embodiment of this invention is a composition that includes a polymer and one or more functionalized carbon materials as described herein.

Another embodiment of this invention is a film prepared from this composition, as well as articles made from such film. Another embodiment of this invention is a membrane prepared from the above described composition.

In a further embodiment of this invention, the polymeric component of a composition may contain cation exchange groups. In such event, a further embodiment is provided in which a film prepared from such composition is used to make a membrane. The invention is thus also further directed to a membrane and an electrode assembly, an electrochemical cell or a fuel cell that contains such a membrane.

Another embodiment of this invention is a composition that includes a functionalized carbon material as described herein and an electrocatalytic metal.

A further embodiment of this invention is an anode electrocatalyst that includes one or more noble metals and a functionalized carbon material as described herein. The invention is thus also further directed to an electrochemical cell or a fuel cell that contains such an anode electrocatalyst.

### DETAILED DESCRIPTION OF THE INVENTION

A composition of this invention contains a polymer and a functionalized carbon material as described herein. These compositions can be made into films by any film forming method as typically used in the art, such as solvent casting on a heated surface, or thermal pressing of an extrudate. A film prepared from a composition of this invention can be incorporated into a polymer membrane suitable for use in a fuel cell and other electrochemical cells, demonstrating good ionic conductivity and solubility with the polymer.

The present invention is thus directed in part to a membrane made from a composition hereof wherein the composition contains carbon materials with fluorinated functionalities. The membrane may be made from a film formed from a composition as used herein, but may also be made by other means that do not involve a step of film formation. These films and membranes that contain functionalized carbon materials are suitable for use in fuel cells, batteries, electrolysis cells, ion exchange membranes, sensors, electrochemical capacitors, and modified electrodes. The invention is also directed, however, to membranes that additionally contain electrically-conductive, catalytically-active particles, and to electrode assemblies, electrochemical cells and fuel cells that contain such a membrane.

Functionalized Carbon Materials

The functionalized carbon materials used in the compositions of this invention, and films and apparatus made therefrom, include carbon materials having unsaturation that are functionalized by addition chemistry performed on one or more surface C—C double bonds, include compositions of more than one of such carbon materials, and also include compositions of one or more of such carbon materials with one or more polymers and/or catalytic metals, as set forth herein.

The carbon materials functionalized in this invention are those that have substantial carbon content, contain six-membered rings, exhibit curving of one or more graphitic planes (generally by including five-membered rings among the hexagons formed by the positions of the carbon atoms), and have at least one dimension on the order of nanometers. Examples of such carbon materials include, but are not limited to, a fullerene molecule and a curved carbon nanostructure. A curved carbon nanostructure includes, but is not limited to, a carbon nanotube (CNT), a fullerenic nanoparticle and carbon black, but a curved carbon nanostructure does not include a fullerene molecule.

A fullerene is a spherical allotrope of carbon, and takes the form of a closed cage molecule composed entirely of an even number of carbon atoms in the sp²-hybridized state. It constitutes the third form of pure carbon, the other two being diamond and graphite. Fullerenes typically each have 12 pentagons, but differing numbers of hexagons. The most abundant species is the C₆₀ molecule, which is a truncated icosahedron (the highest symmetry structure possible) and has 12 pentagons and 20 hexagons. The second most abundant species of the fullerene family is C₇₀. The C₆₀ species was first reported by Kroto et al in “Carbon Vapor Produced by Laser Irradiation of Graphite, a ‘Carbon vaporization’ Technique”, in Nature, volume 318, pages 162-164 (1985).

Fullerenes containing up to 400 carbon atoms have also been identified including, for example, C₂₄, C₃₀, C₆₀, C₇₀, C₇₆, C₇₈, C₈₄, C₉₀, C₉₄, C₉₆ and C₁₂₀. The so-called “giant fullerenes” may be characterized as C₂ₙ where n is 50 or more. Giant fullerenes may be formed along with smaller fullerenes in carbon vaporization systems. For example, as reported in U.S. Pat. No. 5,985,232 (which is incorporated in its entirety as a part hereof for all purposes), carbon clusters up to C₆₃₂, all even numbered and interpreted to be fullerenes, have been observed in molecular beam mass spectrometer (MBMS) analysis of the vapor from laser vaporization of graphite. Mass spectroscopy of solvent extracts of soot from electrical vaporization of carbon rods has showed species interpreted to be C₁₈₈, C₂₀₈ and C₂₆₆. Transmission electron microscopy (TEM) of crystals consisting largely of C₆₀ has revealed apparently ellipsoidal fullerenes estimated to be about C₁₃₀. Scanning tunneling microscopy (STM) of extracts of soot from electrical vaporization of carbon showed spheres of 1 to 2 nm diameter, which may correspond to fullerenes up to C₃₃₀.

Fullerenes include not only single-walled but also multi-walled cages consisting of stacked or parallel layers.

Fullerenes are, in general, synthesized using a laser to ablate graphite, burning graphite in a furnace or by producing an arc across two graphite electrodes in an inert atmosphere. Other methods include negative ion/desorption chemical ionization, and combustion of a fullerene-forming fuel. Combustion is the method typically used for high volume production. In each method, condensable matter comprising a mixture of soot, other insoluble condensed matter, C₆₀, C₇₀ and higher as well as lower numbered fullerenes, and polycyclic aromatic hydrocarbons (PAH) in varying amounts is collected, with the total fullerene fraction typically between 5 and 15% of the total material collected, with the soot being 80%-95% of the remaining total material.

In other instances, fullerenes have been produced by high temperature vaporization of solid graphite rods by resistive heating or arc heating in the presence of a few to several torr of rare gas. The soot produced by the vaporization contains varying levels of fullerenes, depending on the vaporization conditions. The process described by Kroto for making fullerenes involved vaporizing the carbon from a rotating solid disk of graphite into a high-density helium flow using a focused pulsed laser. That process did not utilize a temperature controlled zone for the growth and annealing of fullerene molecules from the carbon vapor formed by the laser blast.

WO 92/04279 discloses a method for producing fullerenes involving the resistive or arc heating of graphite in the presence of an inert quenching gas to form a black soot material that contains fullerenes, predominantly C₆₀.

U.S. Pat. No. 5,316,636 discloses a process for producing fullerenes by electron beam evaporation of a carbon target in a vacuum. The evaporated carbon atoms or clusters are deposited onto collection substrates that are electrically charged and heated, or neutral and chilled. The resulting carbon soot is extracted to recover fullerenes. This process produces carbon soot that is rich in C₇₀ and higher fullerenes.

U.S. Pat. No. 5,300,203 discloses that fullerenes can be efficiently generated by vaporizing carbon with a laser beam and maintaining the vaporized carbon at conditions selected to promote fullerene growth and formation. This method of fullerene generation may be used to form new compounds including fullerenes surrounding one or more metal atoms, and fullerenes wherein one or more carbon atoms have been substituted with boron or nitrogen.

C₆₀ and C₇₀ have been successfully synthesized and collected in flames by Howard et al (Nature 352, 139-141, 1991). Evidence of high molecular weight ionic species consistent with an interpretation as being fullerenic structures was observed in low-pressure premixed benzene and acetylene flames [Baum et al, Ber. Bunsenges. Phys. Chem. 96, 841-857 (1992)].

Depending on molecular weight, fullerenes may soluble (for example, in toluene or xylene) and thus be solvent extractable. The procedures most commonly used for purifying fullerenes employ significant amounts of organic solvents. The solvents are used to first extract a fullerene mixture from insoluble soot and other insoluble condensed materials and then are used to purify and separate the individual fullerenes. Typically, the different constituents of the condensed matter are collected by filtration or some similar separation technique, and the soluble components are extracted by a high energy-input extraction process such as sonication or soxhlet extraction using an organic solvent such as toluene. The extraction solution is then typically filtered to eliminate the particulate matter, and then purified by high performance liquid chromatography (HPLC), which separates the fullerenes from soluble impurities, such as PAH and aliphatic species, as well as separating individual fullerene species from other fullerene species.

Fullerenes may be obtained commercially from suppliers such as Carbon Nanotechnologies Incorporated, MER Corporation, Nano-C Corporation, TDA Research Inc., Fullerene International Corp., and Luna Innovations.

A curved carbon nanostructure includes, but is not limited to, a carbon nanotube (CNT), a fullerenic nanoparticle and carbon black. The nano prefix in CNT or nanoparticle refers to dimensions in the nanometer range.

With the aid of a transition metal catalyst, carbon will assemble into single- or multiple-wall cylindrical tubes that are frequently sealed perfectly at both ends with a semi-fullerene dome, i.e. a spheroidal cap of fullerenic carbon. There may be a conical transition between the cap and the side wall. These tubes are CNTs, which may be thought of as one-dimensional single crystals of carbon. A CNT has cage-like carbon structure made up predominantly of six-member carbon rings, with minor amounts of five-member, and in some cases seven-member, carbon rings.

CNTs may have diameters ranging from about 0.6 nanometers (nm) for a single-wall carbon nanotube (SWNT) up to 3 nm, 5 nm, 10 nm, 30 nm, 60 nm or 100 nm for a SWNT or a multiple-wall carbon nanotube (MWNT). A CNT may range in length from 50 nm up to 1 millimeter (mm), 1 centimeter (cm), 3 cm, 5 cm, or greater. A CNT will typically have an aspect ratio of the elongated axis to the other dimensions greater than about 10. In general, the aspect ratio is between 10 and 2000.

A SWNT has a single shell. But in a MWNT, the inner nanotube may be surrounded by or “nested” within a number of concentric and increasingly larger tubes or particles of different diameter, and thus is known as a “nested nanotube”. The MWNT may have two, five, ten, fifty or any greater number of walls (concentric CNTs). Thus, the smallest diameter tube is encapsulated by a larger diameter tube, which in turn, is encapsulated by another larger diameter nanotube, and so on.

SWNTs are much more likely to be free of defects than MWNTs because the latter have neighboring walls that provide for easily-formed defect sites via bridges between unsaturated carbon valances in adjacent tube walls. Since SWNTs have fewer defects, they are stronger and more conductive.

In defining the CNTs used in this invention, the system of nomenclature used is that which is described by Dresselhaus et al in Science of Fullerness and Carbon Nanotubes, chapter 19, pages 756-760 [Academic Press, San Diego, 1996 (ISBN 0-12-221820-5)]. SWNTs are distinguished from each other by a double index (n,m) where n and m are integers that describe how to cut a single strip of hexagonal “chicken-wire” graphite so that it makes the tube perfectly when it is wrapped onto the surface of a cylinder and the edges are sealed together. When the two indices are the same, m=n, the resultant tube is said to be of the “arm-chair” (or n,n) type, since when the tube is cut perpendicular to the tube axis, only the sides of the hexagons are exposed and their pattern around the periphery of the tube edge resembles the arm and seat of an arm chair repeated n times.

Most CNTs, as presently prepared, are in the form of entangled tubes. Individual tubes in the product differ in diameter, chirality and number of walls. Moreover, long tubes show a strong tendency to aggregate into “ropes” held together by Van der Waals forces. These ropes are formed due to the large surface areas of nanotubes and can contain tens to hundreds of nanotubes in one rope.

CNTs may be produced by a variety of methods, and, in addition, are available commercially. Methods of CNT synthesis include laser vaporization of graphite [Thess et al, Science 273, 483 (1996)], arc discharge [Journet et al, Nature 388, 756 (1997)], and the HiPCo (high pressure carbon monoxide) process [Nikolaev et al, Chem. Phys. Lett. 313, 91-97 (1999)]. Other methods for producing CNTs include chemical vapor deposition [Kong et al, Chem. Phys. Lett. 292, 567-574 (1998); and Cassell et al, J. Phys. Chem. 103, 6484-6492 (1999)]; and catalytic processes both in solution and on solid substrates [Yan Li et al, Chem. Mater. 13(3); 1008-1014 (2001); and A. Cassell et al, J. Am. Chem. Soc. 121, 7975-7976 (1999)].

As reported in U.S. Pat. No. 6,645,455, one or more transition metals of Group VIB chromium [e.g. (Cr), molybdenum (Mo), tungsten (W)] or Group VIII B transition metals [e.g. iron (Fe), cobalt (Co), nickel (Ni), ruthenium (Ru), rhodium (Rh), palladium (Pd), osmium (Os), iridium (Ir) and platinum (Pt)] catalyze the growth of CNTs and/or ropes when contacted with a carbon bearing gas such carbon monoxide and hydrocarbons, including aromatic hydrocarbons, e.g. benzene, toluene, xylene, cumene, ethylbenzene, naphthalene, phenanthrene, anthracene or mixtures thereof; non-aromic hydrocarbons, e.g. methane, ethane, propane, ethylene, propylene, acetylene or mixtures thereof; and oxygen-containing hydrocarbons, e.g. formaldehyde, acetaldehyde, acetone, methanol, ethanol or mixtures thereof. Mixtures of one or more Group VIB or VIIIB transition metals also selectively produce SWNTs and ropes of SWNTs.

A further method of making CNTs and/or ropes of CNTs involves supplying carbon vapor to the live end of one or more of CNTs growing by a catalytic process in which there is a “live end” of the nanotube in contact with a nanometer-scale transition metal particle that serves as a catalyst. The live end of the nanotube is maintained in contact with a carbon bearing feedstock gas in an annealing zone at an elevated temperature. Carbon in vapor form may be supplied by an apparatus in which a laser beam impinges on a carbon target that is maintained in a heated zone. Alternatively carbon may be added to the live end by the direct action of the catalytic particle in the annealing zone with a carbon-bearing feedstock gas such as carbon monoxide and hydrocarbons, including aromatic hydrocarbons, e.g. benzene, toluene, xylene, cumene, ethylbenzene, naphthalene, phenanthrene, anthracene or mixtures thereof; non-aromic hydrocarbons, e.g. methane, ethane, propane, ethylene, propylene, acetylene or mixtures thereof; and oxygen-containing hydrocarbons, e.g. formaldehyde, acetaldehyde, acetone, methanol, ethanol or mixtures thereof.

A particularly useful form of CNTs is that which is made by the high pressure carbon monoxide disproportionation process (these CNTs are referred to herein as “HiPCO” CNTs). These CNTs have been chemically processed to remove contaminants that include catalyst seeds. Various approaches have been taken to purify them, essentially based on one or more of the following: oxidation processes with oxidizing acids or mixtures of acids (nitric and/or sulphuric, and/or hydrochloric acid), filtration, separation by centrifugation or chromatography.

Depending on their atomic structure CNTs may have either metallic or semiconductor properties. Tubes that have C—C bonds running parallel to the circumference of the tube are in the arm-chair configuration and are metallic, and have high electrical and thermal conductivity. Tubes that have bonds running parallel to the axis of the tube are in the zig-zag configuration, and are generally semi-conducting. Additionally, there are tubes that have a helical, chiral structure and are often semi-conducting. These properties, in combination with the small dimensions of the tubes makes them particularly attractive for use in fabrication of nano-devices. The diversity of tube diameters, chiral angles and aggregation states in nanotube samples obtained from various preparation methods can, however, be a hindrance to such efforts. Aggregation is particularly problematic because the highly polarizable, smooth-sided tubes readily form parallel bundles or ropes with a large van der Waals binding energy. This bundling perturbs the electronic structure of the tubes, and hinders attempts to separate the tubes by size or type or to use them as individual macromolecular species. Because most populations of CNTs are aggregated, it is important to address this situation for the purposes of obtaining discreet populations of nanotubes that have a uniform length, diameter, chirality or other physical properties.

U.S. Ser. No. 10/716,347, which is incorporated in its entirety as a part hereof, reports a method for the facile and inexpensive separation of dispersed carbon nanotubes into populations having discreet characteristics through the use of stabilized solutions of nucleic acid molecules that have the ability to disperse and solubilize CNTS, resulting in the formation of nanotube-nucleic acid complexes. Separation of these nucleic acid associated CNTs is then performed based on common chromatographic means.

A method of separating metallic from semi-conducting SWNTs in a suspension using alternating current dielectrophoresis is reported by Krupke et al in Science, 301, 344-347 (2003).

Other useful forms of a curved carbon nanostructure include a fullerenic nanoparticle and carbon black. One type of fullerenic nanoparticle has a substantial amount of true fullerene character as it is curved in two dimensions. It is typically an open or closed cage carbon structure that has at least one dimension on the order of nanometers and is made up of five-member and six-member, and in some cases four-member and/or seven-member, carbon rings. Although the dimensions of the particle are often beyond those typically associated with a molecule, the atomic interactions within the nanoparticle are typically covalent in nature.

In some instances, the nanoparticle may be of approximately the same dimensions along all axes such as when it has a single shell. In other instances, the nanoparticle may be polyhedral in shape, or take the form of multiple polyhedral shells separated by about 0.34 nm (close to the interlayer spacing of graphite).

A polyhedral may be thought of as exhibiting a generally spheroidal shape although its surface is made up of smoothly continuing curved junctions between adjacent flat face. Unlike a true sphere whose surface is of approximately constant curvature and whose surface is at all points equidistant from the center, the term “spheroidal” is used to describe structures that are generally sphere-like, but are elongated along one or more axes. These spheroidal polyhedrals may have a relatively high curvature at the edges (where two faces meet) and vertices (where three faces meet).

Multishelled polyhedrons may be viewed as “nested” because an inner shell is enclosed within a polyhedral shell of larger dimension, the term “shell” referring to a curved fullerenic surface that can be ordered so as to form a nested structure. Nested spheroidal polyhedron shells of carbon have been observed in carbon deposited from an arc discharge at 10⁻⁷ torr, as reported by Iijima in J. Phys. Chem. 91, 3466-3467 (1987). The central shells ranged from about 1 nm diameter to much larger, some containing one- and two-layered giant fullerenes equivalent to about C₃₇₀₀ and larger. Essentially spherical onion structures with up to about 70 shells have been produced by intense electron-beam irradiation of carbon soot collected from an arc-discharge apparatus. Also known, and useful as fullerenic nanoparticles, are nested spheres and polyhedral spheroids 5-20 nm in diameter and other polyhedrons of approximately triangular, tetragonal, pentagonal and hexagonal cross section.

Other types of fullerenic nanoparticles have shapes that, in large part, result from the curvature of a graphene sheet, which contains only six-member rings, and is thus curved in only one dimension. The edges of large regions of graphitic character are often but not always zipped together by the formation of five-member rings to form a shape such as a cone, a truncated cone (a “lampshade”), a prolate, trigonous or toroidal shape, or other complex shapes having both concave and convex curvature. In addition to the regions of graphitic character, these nanoparticles will often contain regions that have true fullerene character in the sense of a structure containing both six-member and five-member carbon rings. The five-member rings are often embedded where a structure becomes at least partially closed, and the five-membered rings introduce disinclination defects in the otherwise planar graphitic network.

Another form of fullerenic nanoparticles is the contents of fullerenic soot, which is typically composed of spherules of carbon made up curved graphene sheets that have substantial fullerenic character. The spherules have dimensions similar to conventional carbon black and thermal black (finely divided carbon), i.e. in the range of 5 nm to 1000 nm. Fullerenic character is noted by the presence of five-member and six-member carbon rings that result in curved sheets of carbon. Fullerenic soot is made up of spherules of curved carbon sheets that may be stacked or nested within other carbon sheets of similar geometry.

Soot is a solid particulate carbonaceous material containing primarily carbon but including hydrogen, oxygen and other elements depending on the composition of the material from which the soot is formed. Combustion-generated soot contains significant amounts of hydrogen and some oxygen, as well as trace amounts of other elements that are present in the flame. Soot produced in carbon vaporization, or other fullerene-synthesis processes, may contain smaller amounts of oxygen and hydrogen and various amounts of other elements depending on the purity of the carbon source material. The soot structure consists primarily of layers of polycyclic aromatic hydrocarbon (“PAH”) that, depending on the formation conditions, may be planar or curved, and some of each shape may be present in various amounts. The layers exhibit various degrees of mutual alignment ranging from an amorphous structure early in the formation process to an increasingly crystal-like structure, either graphitic (planar layers), fullerenic (curved layers), or some of both, as residence time at high temperature increases. The soot particle is an aggregate or agglomerate of approximately spheroidal units referred to as primary particles or spherules. The number of spherules per aggregate can be as small as one or as large as 100 or more, and the shape of the aggregate can range from single-strand chains of spherules to branched chains and grape-like clusters, depending upon formation conditions. Soot may include a variety of closed-cage and open-cage nanoparticles having multiple nested or parallel layers or walls, shapes ranging from spheroidal to elongated, including onion-like nanoparticles with similar dimensions in all directions.

A fullerenic nanoparticle may be prepared by flame combustion of an unsaturated hydrocarbon fuel and oxygen in a burner chamber at sub-atmospheric pressures. The condensibles of the flame, containing the fullerenic nanoparticles, are collected as a solid or liquid at a post-flame location. The condensibles may include nanoparticles formed within the flame or during the collection process, and may include vapors which are collected as they exit the flame. Representative fuels include ethylene, indene, benzene, toluene, cresol, xylene, pyrrole, pyrroline, pyrrolidine, thiophene, pyridine, pyridizine, pyrazine, pyrimidine, indole, indoline, furan, naphthalene, indan, anthracene, pyrene, chrysene and styrene.

The fuel may be combusted in a flame at a temperature in the range of about 1700 to 2100 K. The burner chamber pressure may be in the range of about 20 to 300 torr, and is more preferably about 80 to 200 torr; diluent concentration may be in the range of 0 to about 50 vol %; and the carbon to oxygen ratio (C/O) may be in the range of about 0.85 to 1.10. Suitable diluents include argon, nitrogen, carbon dioxide, steam, flue gases and mixtures thereof.

Organic solvents, such as toluene, may be used to purify the condensed aggregation of fullerenic nanoparticles, and recover a usable product. The solvent is used to first extract the soluble from the insoluble particles, and then also to purify the individual components of the soluble fraction. The different constituents of the condensed aggregation of nanoparticles are collected by filtration or equivalent technique, and the soluble components are extracted by a high energy-input extraction process such as sonication or soxhlet extraction using an organic solvent such as toluene. The extraction solution is then typically filtered to eliminate any undesired matter, and is then purified by high performance liquid chromatography (HPLC), which separates the components from soluble impurities and separates individual components from each other. Insoluble components may be separated by size.

Methods for preparing and recovering a fullerenic nanoparticle are further described in U.S. Pat. No. 5,985,232 and US 2004/057,896, each of which is incorporated in its entirety as a part hereof. Fullerenic nanoparticles are available commercially from suppliers such as Nano-C Corporation, Westwood Mass.

Carbon black is a powdered form of highly dispersed, amorphous elemental carbon. It is a finely divided, colloidal material in the form of spheres and their fused aggregates. Types of carbon black are characterized by the size distribution of the primary particles, and the degree of their aggregation and agglomeration. Average primary particle diameters range from 10 to 400 nm, while average aggregate diameters range from 100 to 800 nm. Carbon black is often popularly, but incorrectly, regarded as a form of soot. Carbon black is manufactured under controlled conditions whereas soot is randomly formed, and they can be distinguished on the basis of tar, ash content and impurities. Carbon black is made by the controlled vapor-phase pyrolysis and/or thermal cracking of hydrocarbon mixtures such as heavy petroleum distillates and residual oils, coal-tar products, natural gas and acetylene. Acetylene black is the type of carbon black derived from the burning of acetylene. Channel black is made by impinging gas flames against steel plates or channel irons (from which the name is derived), from which the deposit is scraped at intervals. Furnace black is the term sometimes applied to carbon black made in a refractory-lined furnace. Lamp black, the properties of which are markedly different from other carbon blacks, is made by burning heavy oils or other carbonaceous materials in closed systems equipped with settling chambers for collecting the solids. Thermal black is produced by passing natural gas through a heated brick checkerwork where it thermally cracks to form a relatively coarse carbon black. Over 90% of all carbon black produced today is furnace black. Carbon black is available commercially from numerous suppliers such as Cabot Corporation.

In this invention, functionalization is achieved by addition chemistry performed on one or more surface C—C double bonds of a carbon nanostructure. One suitable method for performing an addition reaction is a cycloaddition reaction such as that of fluoroalkenes with themselves and other alkenes to form fluorocyclobutane rings. This is referred to herein as a “2+2” addition. Another suitable method is the addition of fluorinated radicals to the C—C double bond. These types of processes are described by Hudlicky in Chemistry of Organic Fluorine Compounds, 2nd ed, Ellis Horwood Ltd., 1976.

In one embodiment of this invention, such a cycloaddition process may be performed in a reaction brought about by heating a fullerene molecule with a compound described generally by the formula
CF₂═CF—Oₐ—[C(F₂)—C(F)(R)]_{b}—O_{c}—[C(F₂)]_{d}-T I
wherein

a is 0 or 1;

b is 0 to 10;

c is 0 or 1;

d is 1 to 10;

each R is independently selected from the group consisting of H, F, methyl, branched or straight-chain perfluorinated C₁-C₁₀ alkyl, phenyl and perfluorinated aryl groups;

each T is independently selected from the group consisting of —CO₂H, —SO₃H, —SO₂NH₂, —SO₂NHSO₂J and —PO₃H₂ groups; and

each J is independently selected from the group consisting of F, methyl, branched or straight-chain perfluorinated C₁-C₁₀ alkyl, phenyl and perfluorinated aryl groups. The compounds described in Formula I may be prepared in the manner set forth in U.S. Pat. No. 3,282,875 and U.S. Pat. No. 3,641,104.

The above reaction will produce a fullerene molecule comprising n carbon atoms wherein m functional branches described generally by the formula
—C(F₂)—C(−)(F)—Oₐ—[C(F₂)—C(F)(R)]_{b}—O_{c}—[C(F₂)]_{d}-T II
are each covalently bonded to the fullerene through formation of a 4-member ring with the unsaturated pi system of the fullerene, and a, b, c, d, R and T are as set forth above.

The bonds resulting from opening a C═C bond in both the fullerene and a compound of Formula I, the ensuing 2+2 cycloaddition, create the 4-member ring. As the ring itself is not shown in Formula II, its presence is indicated by the incomplete bonds of the —C(F₂) and C(−) residues shown therein. This same graphical representation of a 4-membered ring is also used in Formulae IV, VI, VIII and X.

In other alternative embodiments:

a and b may both be 0, c may be 0 or 1 (preferably 1), and d may be 1 to 4 or 1 to 2;

a may be 1, c may be 1, and b and/or d may be 1 to 4 or 1 to 2;

a, b and c may all be 0, and d may be 1 to 4 or 1 to 2;

a may be 0, c may be 1, and b may be 1 to 4 or 1 to 2;

when a and b are both 0, c may be 0 or 1 (preferably 1), d may be 1 to 4 or 1 to 2, T may be selected from the group consisting of —SO₃H, —SO₂NH₂, —SO₂NHSO₂J and —PO₃H₂ groups, and J may be F or CF₃ groups;

when a is 1 and c is 1, b and/or d may be 1 to 4 or 1 to 2, R may be CF₃, T may be selected from the group consisting of —SO₃H, —SO₂NH₂, —SO₂NHSO₂J and —PO₃H₂ groups, and J may be F or CF₃ groups;

when a, b and c are all 0, d may be 1 to 4 or 1 to 2, T may be selected from the group consisting of —SO₃H, —SO₂NH₂, —SO₂NHSO₂J and —PO₃H₂ groups, and J may be F or CF₃ groups; and/or

when a is 0 and c is 1, b may be 1 to 4 or 1 to 2, R may be CF₃, d may be 2 to 4, T may be selected from the group consisting of —SO₃H, —SO₂NH₂, —SO₂NHSO₂J and —PO₃H₂ groups, and J may be F or CF₃ groups.

In another embodiment of this invention, a cycloaddition process may be performed in a reaction brought about by heating a fullerene molecule with a compound described generally by the formula
CF₂═CF—O—[C(F₂)]₂-Q III
wherein

each Q is independently selected from the group consisting of —COG, —CN, —PO₃H₂, and —SO₂F groups; and

each G is independently selected from F, Cl, C₁-C₈ alkoxyl and C₆-C₁₂ aryloxy groups. The compounds described by Formula III may be prepared in the manner set forth in U.S. Pat. No. 4,358,545.

The above reaction will produce a fullerene molecule comprising n carbon atoms wherein m functional branches described generally by the formula
—C(F₂)—C(—)(F)—O—[C(F₂)]₂-Q IV
are each covalently bonded to the fullerene through formation of a 4-member ring with the unsaturated pi system of the fullerene, and Q is as set forth above.

In other alternative embodiments, Q may be a —SO₂F group.

In a further embodiment of this invention, a cycloaddition process may be performed in a reaction brought about by heating a fullerene molecule with a compound described generally by the formula
CF₂═CF—O—[C(F₂)—C(F)(R)]_{b}—O—[C(F₂)]_{d}-Q V
wherein

b is 1 to 10;

d is 1 to 10;

each R is independently selected from the group consisting of H, F, methyl, branched or straight-chain perfluorinated C₁-C₁₀ alkyl, phenyl and perfluorinated aryl groups; and

each Q is independently selected from the group consisting of —COG, —CN, —PO₃H₂, and —SO₂F groups; and

each G is independently selected from F, Cl, C₁-C₈ alkoxyl and C₆-C₁₂ aryloxy groups. The compounds described in Formula V may be prepared in the manner set forth in U.S. Pat. No. 3,282,875 and U.S. Pat. No. 3,641,104.

The above reaction will produce a fullerene molecule comprising n carbon atoms wherein m functional branches described generally by the formula
—C(F₂)—C(—)(F)—O—[C(F₂)—C(F)(R)]_{b}—O—[C(F₂)]_{d}-Q VI
are each covalently bonded to the fullerene through formation of a 4-member ring with the unsaturated pi system of the fullerene, and b, d, R and Q are as set forth above

In other alternative embodiments, b and/or d may be 1 to 4 or 1 to 2, R may be a CF₃ group, and/or Q may be a —SO₂F group.

In yet another embodiment of this invention, a cycloaddition process may be performed in a reaction brought about by heating a fullerene molecule with a compound described generally by the formula
CF₂═CF—[C(F₂)—C(F)(R)]_{b}—[C(F₂)]_{d}-Q VII
wherein

b is 0 to 10;

d is 1 to 10;

each R is independently selected from the group consisting of H, F, methyl, branched or straight-chain perfluorinated C₁-C₁₀ alkyl, phenyl and perfluorinated aryl groups; and

each Q is independently selected from the group consisting of —COG, —CN, —PO₃H₂, and —SO₂F groups; and

each G is independently selected from F, Cl, C₁-C₈ alkoxyl and C₆-C₁₂ aryloxy groups. The compounds described in Formula VII may be prepared in the manner set forth in WO 00/24709.

The above reaction will produce a fullerene molecule comprising n carbon atoms wherein m functional branches described generally by the formula
—C(F₂)—C(−)(F)—[C(F₂)—C(F)(R)]_{b}—[C(F₂)]_{d}-Q VIII
are each covalently bonded to the fullerene through formation of a 4-member ring with the unsaturated pi system of the fullerene; and b, d, R and Q are as set forth above.

In other alternative embodiments, b and/or d may be 1 to 4 or 1 to 2, R may be a CF₃ group, and/or Q may be a —SO₂F groups.

In yet another embodiment of this invention, a cycloaddition process may be performed in a reaction brought about by heating a curved carbon nanostructure with a compound of the formula
CF₂═CF—Oₐ—[C(F₂)—C(F)(R)]_{b}—O_{c}—[C(F₂)]_{d}-Z IX
wherein

a is 0 or 1;

b is 0 to 10;

c is 0 or 1;

d is 1 to 10;

each R is independently selected from the group consisting of H, F, methyl, branched or straight-chain perfluorinated C₁-C₁₀ alkyl, phenyl and perfluorinated aryl groups;

each Z is independently selected from the group consisting of —CO₂H, —COG, —CN, —SO₂F, —SO₃H, —SO₂NH₂, —SO₂NHSO₂J and —PO₃H₂ groups; and

each J is independently selected from the group consisting of F, methyl, branched or straight-chain perfluorinated C₁-C₁₀ alkyl, phenyl and perfluorinated aryl groups; and

each G is independently selected from F, Cl, C₁-C₈ alkoxyl and C₆-C₁₂ aryloxy groups. The compounds described in Formula IX may be prepared in the manner set forth in U.S. Pat. No. 3,282,875 and U.S. Pat. No. 3,641,104.

The above reaction will produce a curved carbon nanostructure comprising m carbon atoms having functional branches described generally by the formula
—C(F₂)—C(—)(F)—Oₐ—[C(F₂)—C(F)(R)]_{b}—O_{c}—[C(F₂)]_{d}-Z X
wherein each functional branch is covalently bonded to the curved carbon nanostructure through formation of a 4-member ring with an unsaturated pi system of the compound; and wherein a, b, c, d, R and Z are as set forth above.

In other alternative embodiments:

a and b may both be 0, c may be 0 or 1 (preferably 1), and d may be 1 to 4 or 1 to 2;

a may be 1, c may be 1, and b and/or d may be 1 to 4 or 1 to 2;

a, b and c may all be 0, and d may be 1 to 4 or 1 to 2;

a may be 0, c may be 1, b may be 1 to 4 or 1 to 2, and d may be 2 to 4;

when a and b are both 0, c may be 0 or 1 (preferably 1), d may be 1 to 4 or 1 to 2, Z may be selected from the group consisting of —SO₃H, —SO₂NH₂, —SO₂NHSO₂J and —PO₃H₂ groups, and J may be F or CF₃ groups;

when a is 1 and c is 1, b and/or d may be 1 to 4 or 1 to 2, R may be CF₃, Z may be selected from the group consisting of —SO₃H, —SO₂NH₂, —SO₂NHSO₂J and —PO₃H₂ groups, and J may be F or CF₃ groups;

when a, b and c are all 0, d may be 1 to 4 or 1 to 2, Z may be selected from the group consisting of —SO₃H, —SO₂NH₂, —SO₂NHSO₂J and —PO₃H₂ groups, and J may be F or CF₃ groups; and/or

when a is 0 and c is 1, b may be 1 to 4 or 1 to 2, R may be CF₃, d may be 2 to 4, Z may be selected from the group consisting of —SO₃H, —SO₂NH₂, —SO₂NHSO₂J and —PO₃H₂ groups, and J may be F or CF₃ groups.

Any of the processes mentioned above may be run by heating a fullerene molecule with one of the compounds as described, respectively, in Formulae I, III, V, or VII; or by heating a curved carbon nanostructure with a compound as described in Formula IX. The process is run at a temperature in the range of about 100° C. to about 350° C., preferably in the range of about 150° C. to about 300C° C., and more preferably in the range of about 200° C. to about 300° C. The reaction may be run without solvent, or with an organic or halocarbon solvent (such as 1,2,4-trichlorobenzene), under an autogenous pressure of the Formulae I, III, V, VII or IX compound, for a period of time in the range of about 1 hour to about 96 hours, and preferably in the range of about 1 hour to about 18 hours. Typically the reaction is carried out in a sealed, stainless steel pressure vessel, with a pressure gauge for determining the pressure, and an internal thermocouple for measuring temperature.

The product from any of the above reactions is generally isolated by first evaporating, distilling off under reduced pressure, or filtering out all, or most of, any excess of the Formulae I, III, V, VII or IX compound and any solvent (if used). In the case where the product is insoluble, the product may be collected by filtration, and washed with organic or haloorganic solvents such as tetrahydrofuran, methylene chloride, acetone, 1,1,2-trichlorotrifluoroethane or hexafluorobenzene. The product is heated under reduced pressure to remove residual solvent and/or reagents. Alternatively, the product is re-dissolved (or dissolved) in an organic or halocarbon solvent such as tetrahydrofuran, 1,1,2-trichlorotrifluoroethane or hexafluorobenzene, and is then filtered. The solvent is then evaporated under reduced pressure. If the product is soluble, addition of an organic or haloorganic solvent such as hexane allows for collection of the product by filtration, or cooling to −78° C. will precipitate the product in a form in which it can be then be collected. The result is a functionalized fullerene molecule to which has been bonded through a 4-member ring, as a residue of the starting compound, a functional branch as shown respectively in Formulae II, IV, VI and VIII; or a functionalized curved carbon nanostructure to which has been bonded through a 4-member ring, as a residue of the starting compound, a functional branch as shown in Formula X.

Other suitable processes for performing an addition reaction on a carbon nanostructure include (1) a photolysis process such as is known for the preparation of fluoroalkylated organic compounds, and is described, for example, by Habibi et al in J. Fluorine Chem., Volume 53, Pages 53˜60 (1991); and (2) a thermolysis process such as is known for the preparation of fluoroalkylated organic compounds, and is described, for example, by Haszeldine et al in J. Chem. Soc., page 3483 (1952).

In one embodiment of this invention, such a photolysis or thermolysis process may be performed by reacting a fullerene molecule or a curved carbon nanostructure with a compound described generally by the formula
X—[C(F₂)]ₑ—Oₐ—[C(F₂)—CFR]_{b}—O_{c}—[C(F₂)]_{d}-Z XI
or by the formula
[Z—[C(F₂)]_{d}—O_{c}—[C(F₂)—CFR]_{b}—Oₐ—[C(F₂)]ₑ—CO—]₂— XII
wherein

a is 0 or 1;

b is 0 to 10;

c is 0 or 1;

d is 1 to 10;

e is 1 to 10;

each R is independently selected from the group consisting of H, F, methyl, branched or straight-chain perfluorinated C₁-C₁₀ alkyl, phenyl and perfluorinated aryl groups;

each Z is independently selected from the group consisting of —CO₂H, —COG, —CN, —SO₂F, —SO₃H, —SO₂NH₂, —SO₂NHSO₂J and —PO₃H₂ groups;

each G is independently selected from the group consisting of F, Cl, C₁-C₈ alkoxy and C₆-C₁₂ aryloxy groups;

each J is independently selected from the group consisting of F, methyl, branched or straight-chain perfluorinated C₁-C₁₀ alkyl, phenyl and perfluorinated aryl groups; and

each X is independently selected from Br and I groups.

The compounds described by Formula XI may be prepared in the manner set forth in Zhang et al in Huaxue Shijie, 1990, 31, 272; and (b) Bargigia et al in J. Fluorine Chem., 1982, 19, 403. The compounds described by Formula XII may be prepared in the manner set forth in U.S. Pat. No. 5,962,746.

The above reaction will produce a fullerene molecule comprising n carbon atoms wherein m groups described generally by the formula
—[(CF₂)]ₑ—Oₐ—[C(F₂)—C(F)(R)]_{b}—O_{c}—[C(F₂)]_{d}-Z XIII
are each covalently bonded to a carbon atom in the fullerene ; and wherein a, b, c, d, e, R and Z are as set forth above.

The above reaction will also produce a curved carbon nanostructure comprising m carbon atoms having functional branches described generally by the formula
—[(CF₂)]ₑ—Oₐ—[C(F₂)—C(F)(R)]_{b}—O_{c}—[C(F₂)]_{d}-Z XIV
wherein each functional branch is covalently bonded to a carbon atom in the curved carbon nanostructure; and wherein a, b, c, d, e, R and Z are as set forth above.

In other alternative embodiments of either the fullerene molecule containing a functional branch of Formula XIII, or the curved carbon nanostructure containing a functional branch of Formula XIV:

a and b may both be 0, c may be 0 or 1 (preferably 1), and d and/or e may be 1 to 4 or 1 to 2;

a may be 1, c may be 1, and b, d and/or e may be 1 to 4 or 1 to 2;

a, b and c may all be 0, and d and/or e may be 1 to 4 or 1 to 2;

a may be 0, c may be 1, b and/or e may be 1 to 4 or 1 to 2, and d may be 2 to 4;

when a and b are both 0, c may be 0 or 1 (preferably 1), d and/or e may be 1 to 4 or 1 to 2, Z may be selected from the group consisting of —SO₃H, —SO₂NH₂, —SO₂NHSO₂J and —PO₃H₂ groups, and J may be F or CF₃ groups;

when a is 1 and c is 1, b, d and/or e may be 1 to 4 or 1 to 2, R may be CF₃, Z may be selected from the group consisting of —SO₃H, —SO₂NH₂, —SO₂NHSO₂J and —PO₃H₂ groups, and J may be F or CF₃ groups;

when a, b and c are all 0, d and/or e may be 1 to 4 or 1 to 2, Z may be selected from the group consisting of —SO₃H, —SO₂NH₂, —SO₂NHSO₂J and —PO₃H₂ groups, and J may be F or CF₃ groups; and/or

when a is 0 and c is 1, b and/or e may be 1 to 4 or 1 to 2, R may be CF₃, d may be 2 to 4, T may be selected from the group consisting of —SO₃H, —SO₂NH₂, —SO₂NHSO₂J and —PO₃H₂ groups, and J may be F or CF₃ groups.

Utilizing a photolysis alkylation process to prepare a functionalized fullerene molecule or curved carbon nanostructure in accordance with this invention involves photolysing with a mercury lamp or other source of ultraviolet and visible light a solution or slurry of fullerene molecule or curved carbon nanostructure with a compound of Formula XI or XII with or without an organic or halocarbon solvent for a period in the range of about 10 minutes to about 48 hours, usually about 10 minutes to about two hours, and under an inert gas atmosphere such as dinitrogen in the absence of oxygen. Examples of suitable organic or halocarbon solvents include hexafluorobenzene, 1,2,4-trichlorobenzene, Freon™ 113 fluorocarbon from DuPont.

Utilizing a thermal fluoroalkylation process to prepare a functionalized fullerene molecule or curved carbon nanostructure in accordance with this invention involves heating a fullerene molecule or a curved carbon nanostructure with a compound of Formula XI at a temperature in the range of about 160° C. to about 350° C., and preferably in the range of about 180° C. to about 300° C. The reaction may be run with or without an organic or halocarbon solvent, such as 1,2,4-trichlorobenzene or hexafluorobenzene, under an autogenous pressure for a period in the range of about 1 hour to about 96 hours, preferably in the range of about 1 hour to about 48 hours. Typically the reaction is carried out in a glass Fisher-Porter bottle equipped with a pressure gauge, internal thermocouple for measuring temperature, and nitrogen gas inlet for pressurizing the apparatus.

Alternatively, the fullerene molecule or the curved carbon nanostructure may be reacted with a compound of Formula XII at a temperature in the range of about 25° C. to about 100° C. in a halocarbon solvent (such as Freon™ 113 fluorocarbon from DuPont) under an inert gas atmosphere (such as nitrogen) at an autogenous pressure for a period in the range of about 1 hour to about 96 hours.

The product from the above reactions is generally isolated by first distilling off under reduced pressure, or filtering off, all or most of any excess of the Formulae XI or XII compound, halogen and any solvent used. In the case of soluble product, the product is dissolved in a halocarbon such as Freon™ 113 fluorocarbon from DuPont, CClF₂CCl₂F, or hexafluorobenzene and filtered. An organic or halocarbon solvent in which the product is not soluble is added to the filtrate, and the product is isolated by decantation of the supernatant, or collecting the product by filtration, after which it is dried. Alternatively, the halocarbon may be removed under reduced pressure to yield the product, which is washed with an organic solvent and then dried. In the case of insoluble product, the product is collected by filtration, and washed with organic or halocarbon solvents such as methylene chloride, acetone, Freon™ 113 fluorocarbon from DuPont, CClF₂CCl₂F, or hexafluorobenzene. The resulting product is heated under reduced pressure to remove residual solvents or reagents.

In the case of a fullerene molecule having a functional branch as described, respectively, in Formulae II, IV, VI, VIII or XIII,
each n is independently an integer from about 20 to 1000;
each m is independently an integer from about 1 to n/2 when n is an even integer, or is an integer from about 1 to (n−1)/2 when n is an odd integer; and
p groups selected from hydrogen and halogen may each also be covalently bonded to an individual carbon atom of the fullerene molecule where p is an integer from 0 to m.
   In other alternative embodiments, each n may independently be 60 to 100, such as 60, 70 or 84, or mixtures of any two or more thereof.

In the case of a curved carbon nanostructure having a functional branch as described, respectively, in Formulae X or XIV,
m is an integer from 1 to half of the number of carbon atoms in the nanostructure in the case where the number of carbon atoms in the nanostructure is an even integer; or m is an integer from 1 to half minus 0.5 of the number of carbon atoms in the nanostructure when the number of carbon atoms in the nanostructure is an odd integer; and
p groups selected from hydrogen and halogen may each also be covalently bonded to an individual carbon atom of the nanostructure where p is an integer from 0 to m.

In the case of either
(a) a compound as described, respectively, in Formulae III, V, VII or XI to be reacted with a fullerene molecule,
(b) a fullerene molecule having a functional branch as described, respectively in Formulae IV, VI, VIII or XIII,
(c) a compound as described, respectively, in Formulae IX or XII to be reacted with a curved carbon nanostructure, or
(d) a curved carbon nanostructure having a functional branch as described, respectively, in Formulae X or XIV,
   a terminal —SO₂F group may be hydrolyzed to prepare a —SO₃M group, where M is an alkali cation, by treatment with a base such as the hydroxide or carbonate of an alkali metal such as Li, Na, K or Cs in an aqueous alcohol such as methyl or ethyl alcohol. A terminal —SO₂F group can also be converted to the sulfonic acid group —SO₃H by treatment with a base, as above, followed by acidification. If the —SO₃M functionalized material is not soluble in water, as may be the case for functionalized curved carbon nanostructures, acid treatment alone is effective, followed by filtration and washing. If the —SO₃M functionalized material is soluble in water, as may be the case for functionalized fullerene materials, passage through an ion exchange column is appropriate to exchange the alkali cation with the H cation.

In the case of either a fullerene molecule having a functional branch as described, respectively in Formulae II, IV, VI, VIII or XIII, or in the case of a curved carbon nanostructure having a functional branch as described, respectively, in Formulae X or XIV, T may alternatively be selected from the group consisting of —SO₃H, —SO₂NH₂, —SO₂NHSO₂J and —PO₃H₂ groups; J may alternatively be selected from F or CF₃; and the term aryl refers to monocyclic, bicyclic or tricyclic aromatic groups containing from 6 to 14 carbons in the ring portion, such as phenyl, naphthyl, substituted phenyl, or substituted naphthyl, wherein the substituent on either the phenyl or naphthyl ring may be for example C₁₋₄ alkyl, halogen or C₁₋₄ alkoxy. Moreover, the term alkoxy refers to the residue of an alkyl alcohol bonded through the oxygen atom. The term alkyl refers to both straight and branched chain radicals, for example methyl, ethyl, propyl, isopropyl, butyl, t-butyl, isobutyl, pentyl, hexyl, isohexyl, heptyl, 4,4-dimethylpentyl, octyl, 2,2,4-trimethylpentyl, nonyl, decyl, undecyl, dodecyl, and the various branched chain isomers thereof. The chain may be linear or cyclic, saturated or unsaturated, containing, for example, double and triple bonds. The alkyl chain may be interrupted or substituted with, for example, one or more halogen, oxygen, silyl or other substituents. The term aryloxy refers to the residue of an aryl alcohol bonded through the oxygen atom.

Another aspect of this invention is the formation of compositions by the admixture of the functionalized fullerene molecules and the functionalized curved carbon nanostructures, as described above, with (i) each other, (ii) one or more catalytic metals such as Group VIII metals (Ru, Rh, Pd, Os, Ir and/or Pt), particularly Pt and/or Ru; and/or (iii) one or more polymers, including copolymers, that may have varying degrees of fluorination. Where it is desired to prepare a composition containing a Group VIII metal and a functionalized carbon material of this invention, it may also be desired to impregnate the carbon material with the Group VIII metal before reacting a functional group precursor with the carbon material to achieve functionalization.

In general, any film-forming polymer is suitable for use in a composition of this invention. Preferred polymers are those that can withstand high temperatures and/or harsh chemical environments, that are substantially or completely fluorinated, and/or that have ionic functionality (an “ionomer”). Useful ionic functionality includes the presence of a cation exchange group that is capable of transporting protons, such as a sulfonate, carboxylate, phosphonate, imide, sulfonimide or sulfonamide group.

The polymer used to form a composition of this invention may be non-fluorinated, substantially fluorinated or perfluorinated. A substantially fluorinated polymer is one that has fluorine substituted for hydrogen in at least 60 percent of the C—H bonds.

Examples of various polymers suitable for use in a composition of this invention are one or more of the following:
polyethylene,
polypropylene,
poly(phenylene ether),
poly(phenylene sulfide),
aromatic polysulfone,
aromatic polyimide or polyetherimide
polybenzimidazole; or
   a polymer prepared from one or more of the following monomers
a fluorinated vinyl or vinylidine monomer such as include tetrafluoroethylene, hexafluoropropylene, vinyl fluoride, vinylidine fluoride, trifluorethylene, chlorotrifluoroethylene, perfluoro(alkyl vinyl ether), and mixtures thereof;
a fluorinated styrene such as sulfonated α,β,β-trifulorostyrene or p-sulfonyl fluoride-α,β,β-trifulorostyrene (as described, for example, in U.S. Pat. No. 5,422,411);
a sulfonated aryl ether (ether) ketone, where suitable sulfonation is obtained from the presence of a sulfonic acid group or an alkali metal or ammonium salt of a sulfonic acid group; or
a vinyl fluoro sulfonic acid, or an analog thereof, such as a sulfonyl fluoride.

Examples of a suitable vinyl fluoro sulfonic acid or analog include and CF₂═CFR 2—SO₃H, where R² is selected from the group consisting of H, F, and branched or straight-chain perfluorinated C₁-C₁₀ alkyl, phenyl and perfluorinated aryl; CF₂═CF—O—[C(F₂)]₂—SO₂F; and CF₂═CF—O—CF₂—[CF(CF₃)]—O—[C(F₂)]₂—SO₂F.

When a copolymer is desired, it may be formed using a comonomer such as a vinyl or ethylenic compound that is substituted, such as tetrafluorethylene, or has ionic or other functionality.

Polymers as named above, or polymers made from one or more of the above named monomers, may be made by methods known in the art. For example, tetrafluoroethylene can be polymerized in an aqueous medium using little or no dispersing agent and vigorous agitation. Vinylidine fluoride can be polymerized in an aqueous suspension with the aid of an oil-soluble free radical initiator in the presence of a suspending agent and a chain regulator. Poly(phenylene ether) can be made by the oxidative coupling of phenol monomers, such as 2,6-dimethylphenol, using a catalyst such as a copper halide salt and pyridine. Poly(phenylene sulfide) can be made from p-dichlorobenzene and sodium sulfide in a dipolar aprotic solvent. An aromatic polysulfone can be made from 4,4′-dichlorophenylsulfone and a bisphenol in an aprotic solvent at 130-160° C. An aromatic polyimide can be made from an aromatic diamine such as phenylenediamine and an aromatic dianhydride such as pyromellitic dianhydride in a dipolar aprotic solvent. An aromatic polyetherimide can be prepared from a bisphenoxide salt and an aromatic dinitrobisimide. Styrenes may be polymerized by free radical addition using an initiator such as a peroxide. A poly(ether ketone) may be either ether rich or ketone rich, and may be prepared by polymerization of cyclic ester ketone compounds in solution or mass promoted by an initiator, or in solution with a Lewis acid by the reaction of terephthaloyl chloride with 4,4′-diphenoxybenzophenone, or the polycondensation of p-phenoxybenzoyl chloride with itself. A vinyl fluoro sulfonic acid or analog may be polymerized in a liquid medium at moderate heat using an initiator such as an azo initiator.

Other polymers suitable for use in a composition of this invention, and other methods for making such a polymer, are described in sources such as: Savadogo, J. Power Source, 2004, 127, 135; Kreuer, J. Membrane Sci., 2001, 185, 29; Jones et al, J. Membrane Sci., 2001, 185, 41; and Heitner-Wirguin, J. Membrane Sci., 1996, 120, 1.

The compositions of this invention may be formed by mixing a functionalized fullerene molecule and/or a functionalized curved carbon nanostructure with a Group VIII metal and/or a polymer by any mixing means as typically used in the art such as a drum tumbler, double cone blender, ribbon blender, sigma blade mixer, Banbury mixer, kneader or extruder. Films may be made from the compositions of this invention by any film forming method as typically used in the art such as solvent casting on a heated surface, or thermal pressing of an extrudate. Examples of the preparation of such functionalized fullerene molecules, functionalized curved carbon nanostructures, compositions thereof, and films thereof may be found in U.S. Application Ser. No. 60/603,215, filed Aug. 20, 2004, which is incorporated in its entirety as a part hereof for all purposes.

Membrane

A membrane in accordance with this invention is made from a composition of a functionalized carbon material and a polymer having cation exchange groups that can transport protons across the membrane. The cation exchange groups are preferably selected from the group consisting of sulfonate, carboxylate, phosphonate, imide, sulfonimide and sulfonamide groups. Various known cation exchange polymers can be used, including polymers and copolymers of trifluoroethylene, tetrafluoroethylene, styrene-divinyl benzene, α,β,β-trifluorstyrene and the like, in which cation exchange groups have been introduced. α,β,β-trifluorstyrene polymers useful for the practice of the invention are disclosed in U.S. Pat. No. 5,422,411, which is incorporated as a part hereof.

In a preferred form of the invention, the polymer comprises a polymer backbone and recurring side chains attached to the backbone with the side chains carrying the cation exchange groups. For example, copolymers of a first fluorinated vinyl monomer, and a second fluorinated vinyl monomer having a side cation exchange group or a cation exchange group precursor, can be used. A suitable side group for this purpose is a sulfonyl fluoride group (—SO₂F), which can be subsequently hydrolyzed to a sulfonic acid group. Possible first monomers include tetrafluoroethylene, hexafluoropropylene, vinyl fluoride, vinylidine fluoride, trifluorethylene, chlorotrifluoroethylene, perfluoro(alkyl vinyl ether), and mixtures thereof. Possible second monomers include a variety of fluorinated vinyl ethers with cation exchange groups or precursor groups.

Preferably, in a polymer as used in a composition from which a membrane is prepared in this invention, the polymer has a backbone that is highly fluorinated, and the ion exchange groups are sulfonate groups. The term “sulfonate groups” is intended to refer either to sulfonic acid groups or alkali metal or ammonium salts of sulfonic acid groups. “Highly fluorinated” means that at least 90% of the total number of positions for halogen and hydrogen atoms contain fluorine atoms. Most preferably, the polymer backbone is perfluorinated. It is also preferable for the side chains to be highly fluorinated and, most preferably, the side chains are perfluorinated.

A class of preferred polymers for such use in the present invention includes a highly fluorinated, most preferably perfluorinated, carbon backbone, and a side chain represented by Formula IV
—(OCF₂CFR⁷)ₐ—OCF₂CFR⁸SO₃X (IV)
wherein R⁷ and R⁸ are each independently selected from F, Cl or a perfluorinated alkyl group having 1 to 10 carbon atoms, a=0, 1 or 2, and X is H, an alkali metal, or NH₄. The preferred polymers include, for example, polymers as disclosed in U.S. Pat. Nos. 4,358,545 and 4,940,525, which are incorporated as a part hereof. Most preferably, polymer comprises a perfluorocarbon backbone, and the side chain is represented by Formula V
—O—CF₂CF(CF₃)—O—CF₂CF₂SO₃X (V)
wherein X is H ,an alkali metal or NH₄. Polymers of this type are disclosed in U.S. Pat. No. 3,282,875, which is incorporated as part hereof

The equivalent weight of the cation exchange polymer can be varied as desired for the particular application. Equivalent weight is defined herein to be he weight of the polymer in sulfonic acid form required to neutralize one equivalent of NaOH. In the case where the polymer comprises a perfluorocarbon backbone and the side chain is the salt of —O—CF₂—CF(CF₃)—O—CF₂—CF₂—SO₃X, the equivalent weight preferably is 800-1500, and most preferably 900-1200. The equivalent weight of polymers that may be similar to those disclosed in U.S. Pat. Nos. 4,358,545 and 4,940,525 is preferably somewhat lower, e.g. 600-1300.

In the manufacture of a membrane from a composition containing a polymer that has a highly fluorinated polymer backbone and sulfonate ion-exchange groups, the membrane is typically formed with the polymer in its sulfonyl fluoride form since it is thermoplastic in this form, and conventional techniques for making films from thermoplastic polymer can be used. Alternatively, the polymer may be in another thermoplastic form in which —SO₂X groups, where X is CH₃, CO₂ or a quaternary amine, are present. Solution film casting techniques using suitable solvents for the particular polymer can also be used if desired.

If the polymer contained in a film or a membrane is in sulfonyl fluoride form, it can be converted to the sulfonate form (sometimes referred to as ionic form) by hydrolysis using methods known in the art. For example, a polymer may be hydrolyzed to convert it to the sodium sulfonate form by immersing a film or membrane in 25% by weight NaOH for about 16 hours at a temperature of about 90° C. followed by rinsing twice in deionized 90° C. water using about 30 to about 60 minutes per rinse. Another method employs an aqueous solution of 6-20% of an alkali metal hydroxide and 5-40% polar organic solvent, such as dimethyl sulfoxide, with a contact time of at least 5 minutes at 50-100° C. followed by rinsing for 10 minutes. After hydrolyzing, the polymer can be converted if desired to another ionic form by immersion of a film or membrane in a bath containing a 1% salt solution containing the desired cation, or to the acid form by contact with an acid and rinsing. For fuel cell use, the polymer in the membrane is usually in the sulfonic acid form.

A membrane may be prepared as a composite from films of the compositions used in this invention where the films are obtained by any means. One method is to prepare a composition by dispersing a functionalized carbon material in solution or dispersion with a selected cation exchange polymer in a suitable solvent such as an alcohol, DMF, ketone, water or mixed solvents. The dispersion is then cast on a glass plate or on another surface, and the solvents are then removed to give a thin film. In some cases, heating the film to above 150° C. is desirable to improve the mechanical and other properties.

Another method is to form a film for use in a membrane by melt extrusion. A composition of a polymer and the functionalized carbon material is prepared by intimate mixing by grinding and/or milling under appropriate conditions. The resulting materials can be pressed or extruded into thin films thermally.

If desired, a membrane may be prepared from a film obtained by laminating together two films that are prepared from compositions of this invention in which the respective polymers, such as two highly fluorinated polymers, have different ion-exchange groups and/or different ion-exchange capacities. In an alternative embodiment, a membrane may be prepared from a film that is obtained by co-extruding a film from compositions of this invention in which the respective polymers, such as two highly fluorinated polymers, have different ion-exchange groups and/or different ion-exchange capacities. In addition, a membrane may be prepared from a film obtained from a composition containing a blend of two or more polymers, such as two or more highly fluorinated polymers, having different ion-exchange groups and/or different ion-exchange capacities. A film may be formed into a membrane, for example, by pressing a film onto, or applying a film as a decal to, a suitable substrate.

A membrane may optionally include a porous support to improve mechanical properties or decrease cost. The porous support of the membrane may be made from a wide range of components. Suitable materials for a support include a hydrocarbon such as a polyolefin, e.g. polyethylene, polypropylene, polybutylene and copolymers of those materials, and the like. Perhalogenated polymers such as polychlorotrifluoroethylene may also be used as the support. For resistance to thermal and chemical degradation, the support preferably is made of a highly fluorinated polymer, most preferably perfluorinated polymer.

For example, the polymer for the porous support can be a microporous film of polytetrafluoroethylene (PTFE) or a copolymer of tetrafluoroethylene with a monomer such as

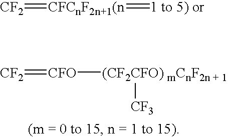

Examples of microporous PTFE films and sheeting suitable for use as a support layer are described in U.S. Pat. No. 3,664,915, which discloses uniaxially stretched film having at least 40% voids; and in U.S. Pat. Nos. 3,953,566, 3,962,153 and 4,187,390, which disclose porous PTFE films having at least 70% voids. Alternately, the porous support may be a fabric made from fibers of the polymers described above woven using various weaves such as the plain weave, basket weave, leno weave or the like.

A membrane can be made using a porous support by coating a cation exchange polymer on the support so that the coating is on the outside surfaces as well as being distributed through the internal pores of the support. This may be accomplished by impregnating the porous support with a solution/dispersion of a composition of a cation exchange polymer, or cation exchange polymer precursor, using a solvent that is not harmful to the polymer or the support under the impregnation conditions such that a thin, even coating of the cation exchange polymer is formed on the support. For example, for applying a coating of perfluorinated sulfonic acid polymer to a microporous PTFE support, a 1-10 weight percent solution/dispersion of the polymer in water mixed with sufficient amount of a polar organic solvent can be used. The support, with the solution/dispersion impregnated therein, is dried to form the membrane. If desired, thin films of the ion exchange polymer can be laminated to one or both sides of the impregnated porous support to prevent bulk flow through the membrane, which can occur if large pores remain in the membrane after impregnation. Alternatively, a composition of the functionalized carbon material, cation exchange polymer and, optionally a catalytic metal, may be formed as an ink, and sprayed on printed onto a support or substrate.

The thickness of the membrane can be varied as desired for a particular electrochemical cell application. Typically, the thickness of the membrane is generally less than about 250 μm, preferably in the range of about 25 μm to about 150 μm.

Membrane Electrode Assembly

A membrane of the present invention can optionally comprise an electrode formed from electrically conductive, catalytically active particles, preferably particles of transition metals, including Group VIII metals such as Ru, Rh and Pt. These particles can be in the form of a catalyst “ink”, either mixed with the functionalized carbon materials or formed as a separate layer. The catalyst layers may be made from particles or materials known to be electrically conductive and/or catalytically active. The catalyst layer may be formed as a film of a polymer that serves as a binder for the catalyst particles. The binder polymer can be a hydrophobic polymer, a hydrophilic polymer or a mixture of such polymers. Preferably, the binder polymer is a polymer having cation exchange groups, and most preferably is the same polymer as in the membrane.

The catalyst layers are preferably formed using an “ink”, i.e. a solution of the binder polymer and the catalyst particles, and optionally the functionalized carbon materials of the present invention, that is in turn used to apply a coating to the membrane. The viscosity of the ink is preferably controlled in a range of 1 to 10² poises, especially about 10² poises, before printing. The viscosity can be controlled by (i) selecting particle sizes, (ii) adjusting the relative content in the composition of the catalytically active particles and binder, (iii) adjusting the water content (if present), or (iv) by incorporating a viscosity regulating agent such as carboxymethyl cellulose, methyl cellulose, hydroxyethyl cellulose, and cellulose and polyethyleneglycol, polyvinyl alcohol, polyvinyl pyrrolidone, sodium polyacrylate or polymethyl vinyl ether.

The area of the membrane to be coated with the ink may be the entire area or only a selected portion of the surface thereof. The catalyst ink may be deposited upon the surface of the membrane by any suitable technique including spreading it with a knife or blade, brushing, pouring, metering bars, spraying and the like. If desired, the coatings are built up to a desired thickness by repetitive application. Areas on the surface of the membrane that require no catalyst materials can be masked, or other means can be taken to prevent the deposition of the catalyst material on such areas. The desired loading of catalyst upon the membrane can be predetermined, and the specific amount of catalyst material can be deposited upon the surface of the membrane so that no excess catalyst is applied. The catalyst particles are preferably deposited upon the surface of a membrane in a range from about 0.2 mg/cm² to about 20 mg/cm².

Electrocatalysts

A functionalized carbon material composition of the present invention can also be used in the preparation of anode electrocatalysts used in electrochemical cells. A composition of a functionalized carbon material hereof and an electrocatalytic metal is incorporated into an anode electrocatalyst. The electrocatalyst can include one or more noble metal catalysts, with the optional additional presence of other metals. Metals useful as electrocatalysts are discussed in
Ullmann's Encyclopedia of Industrial Chemistry, Fuel Cells, 2002, DOI: 10.1002/14356007.a12_{—}055, and
Kirk-Othmer Encyclopedia of Chemical Technology, Fuel Cells, 2002, DOI: 10.1002/0471238961.0621051211091415.a01.pub2;
   which disclosures are incorporated as a part hereof for all purposes.

Preferably the noble metal electrocatalysts are Group VIII metals including platinum or platinum-ruthenium electrocatalysts. These electrocatalysts are typically dispersed on high surface area supports with noble metal concentrations between 5 to 40 weight percent. For industrial applications, support materials include, for example, carbon, carbonaceous materials, aluminum oxide, silicon oxide and ceramic.

The term “noble metal” as used herein means elemental metals that are highly resistant to corrosion and/or oxidation. Noble metals include, for example, ruthenium, rhodium, palladium, silver, rhenium, osmium, iridium, platinum and gold. Preferable noble metals include platinum, ruthenium and mixtures thereof.

The electrocatalyst can be applied to the surface of the SPE that faces the anode, to the surface of the anode facing the SPE, or to both surfaces. In an alternative embodiment, the electrocatalyst is coated on the surfaces of both electrodes facing the SPE, both surfaces of the SPE, or a combination thereof. In accordance with another aspect of this invention, the substrate comprises a SPE. In accordance with a further aspect, the substrate comprises an electrode, preferably an anode.

Known electrocatalyst coating techniques can be used, and will produce a wide variety of applied layers of essentially any thickness ranging from very thick, e.g. 20 μm or more, to very thin, e.g. 1 μm or less.

Electrochemical Cells

The membranes and anode electrocatalysts in accordance with the invention are advantageously employed in electrode assemblies for electrochemical cells, particularly fuel cells, and in battery systems, particularly lithium batteries.

An electrochemical cell may contain an anode compartment containing an anode, a cathode compartment containing a cathode, and a membrane serving as a separator and electrolyte between said anode and cathode compartments. A fuel cell may contain an anode compartment containing an anode, a cathode compartment containing a cathode and a membrane serving as a separator and electrolyte between said anode and cathode compartments.

A further description of electrode assemblies and their use in electrochemical cells can be found in U.S. Pat. No. 5,919,583, which is incorporated in its entirety as a part hereof for all purposes.

Where the composition of this invention is stated or described as comprising, including, containing, having, being composed of or being constituted by certain components, it is to be understood, unless the statement or description explicitly provides to the contrary, that one or more components in addition to those explicitly stated or described may be present in the composition. In an alternative embodiment, however, the composition of this invention may be stated or described as consisting essentially of certain components, in which embodiment components that would materially alter the principle of operation or the distinguishing characteristics of the composition are not present therein. In a further alternative embodiment, the composition of this invention may be stated or described as consisting of certain components, in which embodiment components other than impurities are not present therein.

Where the indefinite article “a” or “an” is used with respect to a statement or description of the presence of a component in the composition of this invention, it is to be understood, unless the statement or description explicitly provides to the contrary, that the use of such indefinite article does not limit the presence of the component in the composition to one in number.

Where an apparatus of this invention is stated or described as comprising, including, containing, having, being composed of or being constituted by certain components, it is to be understood, unless the statement or description explicitly provides to the contrary, that one or more components other than those explicitly stated or described may be present in the apparatus. In an alternative embodiment, however, the apparatus of this invention may be stated or described as consisting essentially of certain components, in which embodiment components that would materially alter the principle of operation or the distinguishing characteristics of the apparatus would not be present therein. In a further alternative embodiment, the apparatus of this invention may be stated or described as consisting of certain components, in which embodiment components other than those as stated would not be present therein.

Where the indefinite article “a” or “an” is used with respect to a statement or description of the presence of a component in an apparatus of this invention, it is to be understood, unless the statement or description explicitly provides to the contrary, that the use of such indefinite article does not limit the presence of the component in the apparatus to one in number.

What is claimed is:

1. A film comprising a polymer and one or more functionalized carbon materials.

2. A membrane comprising one or more functionalized carbon materials and a polymer comprising cation exchange groups.

3. The membrane of claim 2 wherein said cation exchange groups of said polymer are selected from the group consisting of sulfonate, carboxylate, phosphonate, imide, sulfonimide and sulfonamide.

4. The membrane of claim 2 wherein said polymer is highly fluorinated polymer with sulfonate cation exchange groups.

5. The membrane of claim 4 wherein said polymer comprises a highly fluorinated carbon backbone with a side chain represented by the formula
—(OCF₂CFR⁷)ₐ—OCF₂CFR⁸SO₃X
wherein R⁷ and R⁸ are independently selected from F, Cl or a perfluorinated alkyl group having 1 to 10 carbon atoms; a=0, 1 or 2; and X is H, an alkali metal or NH₄.

6. A membrane and electrode assembly comprising the membrane of claim 2.

7. The membrane and electrode assembly of claim 6 wherein the electrode comprises a layer of electrically conductive, catalytically active particles.

8. The membrane and electrode assembly of claim 7 wherein the catalytically active particles comprise one or more noble metals.

9. An electrochemical cell comprising an anode, a cathode and a membrane according to claim 2.

10. An electrochemical cell according to claim 9 that further comprises an anode compartment and a cathode compartment, wherein the membrane further comprises an electrolyte and separates the anode compartment from the cathode compartment.

11. A fuel cell comprising an anode, a cathode and a membrane according to claim 2.

12. A fuel cell according to claim 11 that further comprises an anode compartment and a cathode compartment, wherein the membrane further comprises an electrolyte and separates the anode compartment from the cathode compartment.

13. An anode electrocatalyst comprising an electrocatalytic metal and one or more functionalized carbon materials.

14. An anode elctrocatalyst according to claim 13 wherein the electrocatalytic metal comprises one or more noble metals.

15. The anode electrocatalyst of claim 13 further comprising a catalyst support.

16. An electrochemical cell comprising an anode electrocatalyst according to claim 13, a cathode and a membrane.

17. An electrochemical cell according to claim 16 that further comprises an anode compartment and a cathode compartment, wherein the membrane further comprises an electrolyte and separates the anode compartment from the cathode compartment.

18. A fuel cell comprising an anode electrocatalyst according to claim 13, a cathode and a membrane.

19. A fuel cell according to claim 18 that further comprises an anode compartment and a cathode compartment, wherein the membrane further comprises an electrolyte and separates the anode compartment from the cathode compartment.

20. A membrane comprising the film of claim 1 wherein the polymer comprises cation exchange groups.
